(19) United States
(12) Patent Application Publication
(10) Pub. No.: US 2011/0023807 A1
(43) Pub. Date: Feb. 3, 2011

(54) LASER DEVICE AND METHOD FOR OPERATING SAME

(76) Inventors: Martin Weinrotter, Stuttgart-Botnang (DE); Pascal Woerner, Stuttgart (DE); Juergen Raimann, Weil Der Stadt (DE); Heiko Ridderbusch, Schwieberdingen (DE)

Correspondence Address: KENYON & KENYON LLP, ONE BROADWAY, NEW YORK, NY, 10004, US

(21) Appl. No.: 12/675,483

(22) PCT Filed: May 26, 2008
(86) PCT No.: PCT/EP08/56401

§ 371 Date: Oct. 7, 2010

(30) Foreign Application Priority Data
Aug. 31, 2007 (DE) 102007041531.3

(51) Int. Cl. F02P 19/04; H01S 3/102

(52) U.S. Cl. 123/143 B; 372/25

(57) ABSTRACT

A method for operating a laser device which has a laser-active solid and a preferably passive Q-switch in which the laser device is acted upon by pumped light for generating a laser pulse. According to the present invention, the pumped volume of the laser device acted upon by a pumped light, in particular of the laser-active solid, is changed.

### FIELD OF THE INVENTION

The present invention relates to a method for operating a laser device which has a laser-active solid and a preferably passive Q-switch in which the laser device is acted upon by pumped light for generating a laser pulse.

The present invention also relates to a corresponding laser device.

### BACKGROUND INFORMATION

Laser devices and methods of operating such laser devices may be used in ignition devices of a motor vehicle. The components of conventional laser devices are customarily matched during manufacture in such a way that the characteristics of the generated laser pulse adapts to the requirements of the particular application, such as to a certain internal combustion engine.

Changes in the components of a laser device during their service life, such as a temperature drift, variations in the power of the pumped light, degradation of the passive Q-switch or the like may have the disadvantageous result that the components that had been well matched at the time of manufacture no longer work together in an optimal manner, for example, the generated laser pulses have insufficient pulse energy or no laser pulses are generated at all.

In addition, the conventional laser devices are not very flexible because a characteristic of the generated laser pulses may basically be managed via the applied pumping capacity alone. In particular, for reasons of economy, the performance of the pump may only be increased conditionally. An equally possible variation of the pumping time may not be considered in most applications because the laser pulses must often be provided within a fixed preset time slot.

### SUMMARY

An object of the present invention is to improve a method of operation and a laser device of the above-mentioned type in such a way that a more flexible operation is possible and, in particular, a laser pulse may be reliably generated even when characteristics of components are changed.

This object may be achieved according to an example embodiment of the present invention by changing the pumped volume of the laser device acted upon by the pumped light of the laser-active solid, in particular.

Changing the pumped volume according to the example embodiment of the present invention is advantageous so that a variable pumping intensity may be applied to the laser device that may be adapted to the respective application without changing the time control parameters such as pumping time. In particular, changing the pumped volume according to the example embodiment of the present invention may compensate for any component changes in the laser device that may occur, as for example due to wear and tear.

In addition to the variation in the pulse energy of the generated laser pulse at pre-set pumping capacity and pumping time, the example embodiment of the present invention also makes generation of multiple laser pulses having a lower overall single pulse energy possible. It has been recognized according to the present invention that when the pumped volume is reduced, a breakout intensity in the laser device is reached earlier, so that a corresponding laser pulse is generated earlier than when the pumped volume is higher.

In a highly advantageous specific example embodiment of the method according to the present invention it is provided that the pumped volume is changed by moving the components of the laser device or the entire laser device and the components of a pumped light feed, supplying the pumped light, in relation to one another. Moving the relevant components relative to each other according to the present invention changes the beam path of the pumped light supplied to the laser device, thereby making it possible to vary the pumped volume of the laser device acted upon by pumped light.

A particularly simple and, at the same time, precise movement of the relevant components relative to each other may be achieved by moving the laser-active solid axially and/or radially relative to the pumped light feed. As an alternative or in addition to this, the relative axial or radial movement of the pumped light feed with respect to the laser-active solid could also be considered. As long as the laser device according to the present invention has a monolithic design, the relative movement according to the present invention takes place accordingly, between the monolithic system and the pumped light feed, while in a discrete design of the laser device its individual components, such as the laser-active solid or also the Q-switch, may be moved following the principle of the present invention.

Rotating at least one component of the laser device and/or of the pumped light feed, in particular an optical input system, via which the pumped light is injected into the laser device, may also be provided as a result of a further, very advantageous variant to implement the pumped volume variation according to the example embodiment of the present invention. Another example variant provides the use of a driver having a piezoelectric element and/or an electric motor and/or a hydraulic actuator and/or a pneumatic actuator and/or an actuator that may be manually operated, such as an adjusting screw, for moving the components of the laser device and/or the pumped light. Such a driver may be advantageously situated directly in a housing of the laser device and provide, for example, relative movement of the driven components with respect to the housing and the non-driven components of the laser device.

The manually actuatable driver is preferably designed in such a way that it may be serviced by a service technician easily, for example within the scope of maintenance of the internal combustion engine.

Another very advantageous specific embodiment of the operating method according to the present invention provides that operating information of the laser device is detected, in particular the energy and/or the timing of a generated laser pulse, so that the operation of the laser device may be monitored as well as regulated.

In a highly advantageous manner, the modes contained in the laser pulse may be inferred from the energy of the laser pulse in another variant of the present invention. Hereby, targeted regulation of the laser device according to the present invention is possible, for example, because special modes are excited in the laser device via a predefinable change in the pumped volume.

It may be advantageously provided in a further variant of the present invention to detect a position of the components of the laser device or of the laser device itself and/or of the components of the pumped light feed and/or of an arrangement of the corresponding units relative to each other. For this purpose, an appropriate sensor such as a position coder may be integrated directly into the laser device according to the example embodiment of the present invention. Also in the case of a manually actuatable driver for changing the pumped volume, a manual adjustment of the pumped volume may be verified in a particularly advantageous manner with the help of the sensor provided according to the present invention. The path and position sensor system according to the present invention may transmit the detected data to a control unit of the laser device, for example in real time or, for maintenance purposes, directly to a diagnostic device that may be temporarily connected to the control unit that indicates to the maintenance technician the instantaneous distance between the pumped light feed and an input mirror of the laser device, for example, or even a measure of the set pumped volume, derived therefrom, etc.

In another very advantageous specific embodiment of the operating method according to the present invention it is provided that the operating information is checked for plausibility, in particular using a model. The model may be implemented, for example, in an arithmetic unit of a control device in the form of a computer program and may model the operating sequences of the laser device. As a function of the control quantities actually supplied to the laser device, corresponding output quantities, such as pulse energy of the generated laser pulse and the like, may be calculated supported by the model and compared with the actual performance values measured, and checked for plausibility.

In general, it is very advantageous to implement the changes in the pumped volume as a function of the detected operating information and/or its plausibility check because a particularly reliable operation of the laser device according to the present invention may thus be achieved. For example, the pumped volume may be regulated which automatically compensates for the occurring wear and tear, if it happens, by appropriate adaptation of the pumped volume.

Furthermore, the optical characteristics of an input mirror of the laser device or of other components of the laser device may be advantageously inferred according to an example embodiment of the present invention from the detected operating information. It is possible in particular to infer wear and tear or deterioration in an input mirror or other optical components of the laser device which may occur, for example, when the input mirror or other optical components of the laser device are acted upon with too high radiation intensity. For example, according to an example embodiment of the present invention, such wear and tear as well as deterioration may be detected when no laser pulse is generated even when the pumping capacity supplied to the laser device and pumping time are adequate.

In another very advantageous variant of the present invention it may be provided that as a function of the change in the optical characteristics of the input mirror or its wear or deterioration, a spatial distribution of the pumped light supplied to the input mirror is changed, for example by changing the distance between the pumped light feed and the laser device or by radially moving one of the optical fibers in the pumped light feed which feeds the pumped light onto the input mirror. This advantageously provides the possibility to utilize another, possibly not yet damaged area of the input mirror for injecting the pumped light into the laser device, thereby ensuring the continued operation of the laser device.

In a further variant of the present invention also the spatial distribution of the pumped light supplied to the input mirror may be very advantageously periodically changed, in particular via a corresponding relative movement between the pumped light feed and the input mirror, in such a way that assuming continuous predefinable wear of the input mirror the pumped light is periodically deflected to an area of the input mirror that is not yet worn out, thereby making it possible to increase the lifetime of the laser device, while conventional systems without the example driver according to the invention become inoperable due to a localized damage to the input mirror, for example, and must be replaced. The same procedure may be used for the output mirror.

Another highly advantageous specific embodiment of the operating method according to the present invention provides that at least one part of the pumped light feed is guided mechanically either onto a component of the laser device or the other way around, the guidance allowing, in particular, translation and/or rotation of the pumped light feed in regard to the laser device. The guidance according to the present invention between the corresponding components advantageously ensures that even under the effect of vibrations or other mechanical interfering influences there is always a correct spatial alignment between the pumped light feed and the laser device, which advantageously enables modification of the pumped volume recommended according to the invention at the same time.

In another highly advantageous specific embodiment of the operating method according to the present invention the guidance may be advantageously simultaneously designed to at least partially conduct light as well, so that the guidance may be also used, for example, to inject pumped light laterally, in particular into the laser device. As an alternative, a light-conducting feed may also be used for conducting light, such as spontaneously emitted radiation from the laser device to a detector situated remotely from the laser device which then derives information therefrom about an operating state of the laser device.

According to an example embodiment of the present invention, the pumped light feed may also advantageously be connected to the laser device via a threaded joint so that a rotation of the pumped light feed in relation to the laser device causes the distance between the pumped light feed and the laser device to change. In order to create a threaded joint, the laser device directly or a housing containing the laser device may have a corresponding thread which works with a matching counterpart which is connected to or is situated on the pumped light feed.

A further very advantageous possibility of changing the pumped volume is provided according to the present invention by the fact that at least one flexile optical fiber of the pumped light feed is in a rotatably mounted holding disc which has at least one eccentrically situated bore hole for accommodating at least one flexible optical fiber. The holding disc according to an example embodiment of the present invention is used on the one hand for holding the optical fibers and on the other hand for controlled movement of the optical fibers relative to the laser device. It is also possible to use two second holding discs one behind the other in order to implement complex movements of the optical fiber.

The example operating method according to the present invention is especially advantageously suitable for generating laser pulses in an ignition device of an internal combustion engine of a motor vehicle but may just as well be used for ignition devices of stationary engines or turbines. In general, the example operating method according to the present invention having a corresponding laser device may be used in all laser pulse applications. In particular, the principle according to the present invention may be applied to those laser devices that have an active Q-switch instead of a passive Q-switch.

Additional features, possible applications, and advantages of the present invention are derived from the following description of exemplary embodiments of the present invention, which are illustrated in the figures. All features described or illustrated by themselves or in any desired combination represent the subject matter of the present invention, regardless of their combination in the description or illustration in the figures.

### BRIEF DESCRIPTION OF THE DRAWINGS

FIG. 1 shows a schematic diagram of an internal combustion engine having an ignition device to be used with an example method of the present invention.

FIG. 2 shows a detailed view of a specific embodiment of the ignition device shown in FIG. 1.

FIGS. 3a and 3b show a first scenario of the variation of the pumped volume according to the present invention.

FIG. 4 shows a second scenario of the variation of the pumped volume according to the present invention.

FIG. 5a shows a further scenario of the variation of the pumped volume according to the present invention.

FIGS. 5b and 5c show a detail view of components of a laser device according to the present invention according to FIG. 5a.

FIG. 6 shows another specific embodiment of the laser device according to the present invention.

### DETAILED DESCRIPTION OF EXAMPLE EMBODIMENTS

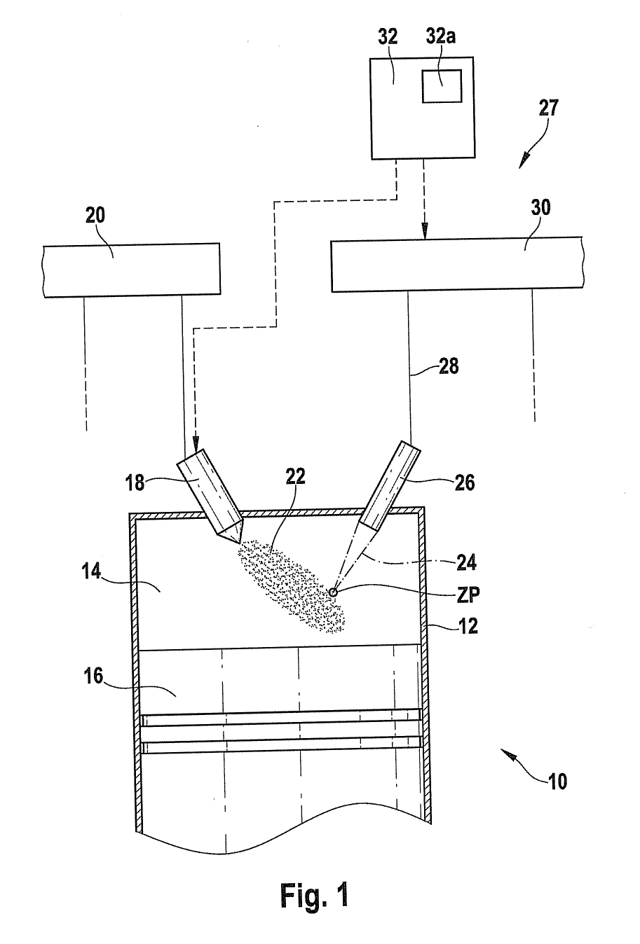

An internal combustion engine is labeled overall with reference numeral 10 in FIG. 1. It is used, for example, for driving a motor vehicle or generator. Internal combustion engine 10 includes a plurality of cylinders, only one of which is labeled with the reference numeral 12 in FIG. 1. A combustion chamber 14 of cylinder 12 is delimited by a piston 16. Fuel reaches combustion chamber 14 directly through an injector 18, which is connected to a pressurized fuel reservoir 20 known as rail or common rail or by premixing a fuel/air mixture in the intake pipe, for example.

Fuel 22 or fuel/air mixture injected into combustion chamber 14 is ignited with the help of a laser pulse 24, which is beamed into combustion chamber 14 by ignition device 27 incorporating laser device 26 and is focused on ignition point ZP with the help of optics. For this purpose, laser device 26 is supplied, via optical fiber device 28, with pumped light generated by a pumped light source 30. Pumped light source 30 is controlled by a control device 32, which also activates injector 18.

Pumped light source 30 may be a semiconductor laser diode, for example, which supplies, via optical fiber device 28, a corresponding pumped light, as a function of a control current, to laser device 26. Although semiconductor laser diodes and other compact pumped light sources are preferably used in motor vehicles, in principle, any type of pumped light source may be used for operating ignition device 27 according to the present invention.

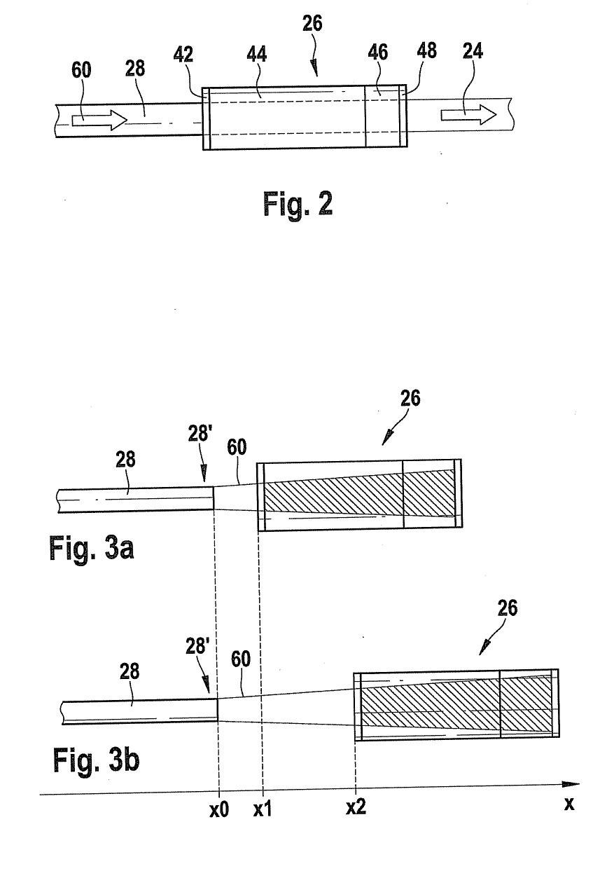

FIG. 2 schematically shows a detail view of laser device 26 of FIG. 1.

As shown in FIG. 2, laser device 26 has a laser-active solid 44, with a passive Q-switch 46, also referred to as a Q-switch, situated optically downstream. Laser-active solid 44, together with passive Q-switch 46, and with input mirror 42 situated on its left in FIG. 2 and output mirror 48, forms a laser oscillator, whose oscillation behavior is a function of passive Q-switch 46 and of the reflectivity of output mirror 48 and thus is controllable at least indirectly.

In the configuration of laser device 26 depicted in FIG. 2, pumped light 60 is transmitted to input mirror 42 via optical fiber device 28 already described above in reference to FIG. 1 by pumped light source 30, also described above. Since input mirror 42 is transparent for the wavelengths of pumped light 60, pumped light 60 penetrates laser-active solid 44, resulting in a conventional population inversion.

While passive Q-switch 46 has its resting state, in which it has a relatively low transmission coefficient, laser operation in laser-active solid 44 or in solid 44, 46 delimited by input mirror 42 and output mirror 48 is avoided. With increasing pumping time, the radiation density increases in laser oscillator 42, 44, 46, 48 so that passive Q-switch 46 fades out, i.e., it assumes a greater transmission coefficient and the laser operation may begin.

This way, a laser pulse 24, also referred to as giant pulse, is created, which has a relatively high peak power. Laser pulse 24 may be connected to combustion chamber 14 (FIG. 1) of internal combustion engine 10 with the help of another optical fiber device or directly via an ignition chamber window of laser device 26 so that fuel 22 or the fuel/air mixture inside is ignited.

If necessary, an optical amplifier may be assigned to laser oscillator 42, 44, 46, 48 to optically amplify laser pulse 24. However, the optical amplifier is not necessary for the use of the method described below.

Since, due to different interfering influences such as fluctuations in temperature, wear and tear, and manufacturing tolerances in the material characteristics of laser-active solid 44, etc., there may be some variation in the operating conditions of laser device 26 in spite of the trigger remaining the same, even to the point of missing laser pulse 24, it is provided according to an example embodiment of the present invention that the pumped volume that may be acted upon by the pumped light of laser device 26 may be changed in order to counteract the above-described effects among others. An increased flexibility in triggering laser device 26 and generating laser pulse 24 is thus advantageously provided by the variation of the pumped volume according to an example embodiment of the present invention.

FIGS. 3a and 3b illustrate the variation of the pumped volume according to the present invention, i.e., the volume of laser device 26 that is acted upon by pumped light 60 via optical fiber device 28.

According to FIG. 3a, laser device 26 is spaced with respect to end section 28′ of optical fiber device 28 at a first distance x1-x0 so that a first pumped volume results in laser device 26, which is here illustrated in FIG. 3a as a shaded area of pumped light beam 60 in laser device 26.

The distance between optical fiber device 28 and laser device 26 increases through a relative movement of laser device 26, which preferably has a monolithic design, to optical fiber device 28 or to its end section 28′ along the x coordinate, as shown in FIG. 3b. In the setting shown in FIG. 3b, laser device 26 is spaced by second distance x2-x0>x1-x0 from end section 28′ of optical fiber device 28, which is fixedly situated here.

The widening of pumped light beam 60 leaving optical fiber device 28 or its end section 28′ results in an increased pumped volume in laser device 26 thanks to the increased distance x2-x0 in FIG. 3b compared to the arrangement as shown in FIG. 3a, illustrated again by a shaded area of pumped light beam 60 in laser device 26.

By increasing the pumped volume as indicated above in order to generate a single pulse according to FIG. 3b, more total pump energy may be fed to laser device 26 so that more energy-rich laser pulses 24 may be generated than in the configuration shown in FIG. 3a, for example.

Of course laser device 26 may be situated fixedly and optical fiber device 28 may be movable as an alternative to moving laser device 26.

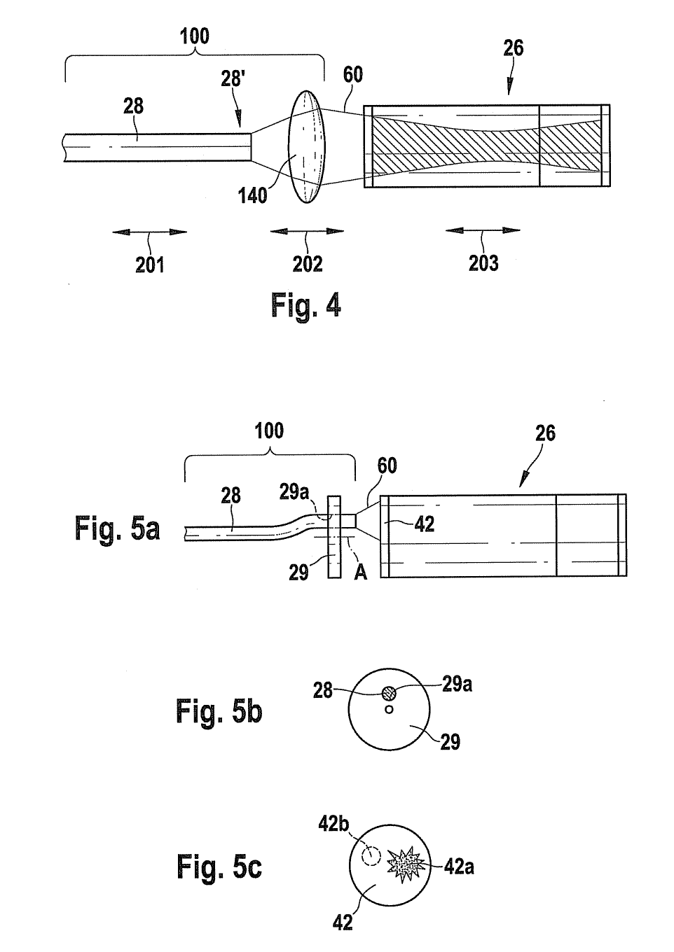

FIG. 4 shows another scenario for laser device 26 being acted upon by pumped light 60 which gives rise to different possibilities for varying the pumped volume according to an example embodiment of an example embodiment of the present invention.

As seen in FIG. 4, a pumped light feed 100 is assigned to laser device 26 according to an example embodiment of the present invention having the already described optical fiber device 28 and therefore also an optical input system 140 symbolized in the form of a biconvex lens for focusing pumped light beam 60 leaving optical fiber device 28, onto laser device 26 or its laser-active solid 44 not shown in detail in FIG. 4. The first double arrow 201 shown in FIG. 4 symbolizes a horizontal mobility of optical fiber device 28 in FIG. 4 which allows, accordingly, variation of the distance of end section 28′ from optical input system 140 and thus a change in the pumped volume of laser device 26 indicated in FIG. 4, again as a shaded area. One or more other optical elements may also be used as optical input system 140.

Alternatively or additionally, optical input system 140 itself may be moved in relation to optical fiber device 28 or to laser device 26 according to an example embodiment of the present invention in order to vary the pumped volume; see double arrow 202.

The variant already described in FIGS. 3a, 3b, which provides for moving laser device 26 back and forth in relation to optical fiber device 28 or also to optical input system 140, is additionally illustrated in FIG. 4 by double arrow 203.

The specific example embodiments of the present invention already described in FIGS. 3a through 4 have in common that axial relative movement of components 28, 140, 26, one with respect to the other, always takes place. Alternatively or additionally, radial relative movement of the components, one with respect to another, may also take place while the principle of the present invention is observed.

Optical fiber device 26 according to FIG. 5a is provided as an example which is in turn assigned to a pumped light feed 100 to supply pumped light 60. Pumped light feed 100 exhibits here a flexibly designed optical fiber device 28 and, in addition, a holding disc 29 assigned to an optical fiber device 28. Holding disc 29 is situated in such a way that it may be rotated about the axis of rotation A indicated with a dash-dot line in FIG. 5a and has an eccentrically situated bore hole, not shown in FIG. 5a in detail, for receiving optical fiber device 28. By rotating holding disc 29 about axis of rotation A, different surface areas of input mirror 42 may be acted upon by pumped light 60 supplied by optical fiber device 28 according to an example embodiment of the present invention. As long as axis of rotation A is not centrally aligned with a cross-sectional area of input mirror 42, pumped light feed 100 may be radially adjusted in relation to laser device 26.

FIG. 5b shows an enlarged detail view of holding disc 29 according to an example embodiment of the present invention showing the eccentrically arranged bore hole 29a for receiving optical fiber device 28. According to the example embodiment of the present invention, several bore holes 29a may be provided in holding disc 29 to which other optical fiber devices (not shown) may be assigned. It is also possible to arrange several holding discs one behind the other. Alternatively, this specific embodiment having a radially adjustable optical fiber 26 may also be used when the output mirror is damaged.

The lifetime of laser device 26 according to an example embodiment of the present invention may be particularly advantageously increased by holding disc 29 and the spatial variation of the beaming of pumped light 60 onto input mirror 42 made thus possible.

Acting upon input mirror 42 (FIG. 5a) with too high pumped light intensity may impair, at least locally, the optical characteristics of input mirror 42 or destroy a portion of the surface of input mirror 42. Such a destroyed area 42a of input mirror 42 is shown in FIG. 5c. Due to holding disc 29 according to the present invention, optical fiber device 28 may be advantageously moved further in relation to optical fiber device 26 and input mirror 42 in such a way that pumped light 60 is no longer injected into destroyed area 42a of input mirror 42 but rather into the still intact area 42b of input mirror 42, making further operation of laser device 26 according to the example embodiment of the present invention possible. This may also be used when the output mirror is damaged.

Other variations of the present invention which allow radial movement of components 100, 26 relative to each other are also possible and may incorporate, for example, suitable driving means such as piezoelectric actuators which move a corresponding component back and forth.

A combination of a radial and an axial adjustability or a construction having rotatable holding disc 29 is also possible in order to make the variation of pumped volume according to the present invention possible.

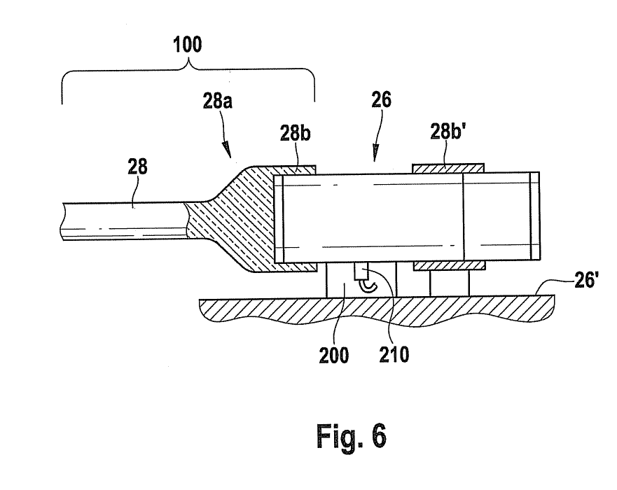

FIG. 6 shows another specific embodiment of laser device 26 according to the present invention in which end section 28a of pumped light feed 100 is widened facing laser device 26 in comparison with an external diameter of the rest of optical fiber device 28 and ends in end section 28b formed as a socket which at least partially surrounds laser device 26.

End section 28b shaped as a socket advantageously provides, according to an example embodiment of the present invention, a mechanical guidance for laser device 26, so that pumped light feed 100 and laser device 26 may be accurately placed in relation to each other even when there are outside interfering influences, such as mechanical vibrations and the like.

In addition to guide 28b, other guide elements 28b′ may be provided that are preferably connected directly with an inside wall 26′ of a housing of laser device 26 not shown in FIG. 6, and thus enable laser device 26 to move easily.

In the specific embodiment of laser device 26 depicted in FIG. 6 a driver 200 is provided that is also preferably fixedly connected to housing wall 26′ and make axial movement of laser device 26 in relation to pumped light feed 100 possible.

Driver 200 may have, for example, a piezoelectric element and/or an electric motor and/or a hydraulic or pneumatic actuator and/or an actuator that may be manually operated such as an adjusting screw, for example. Other electromagnetic actuators such as solenoids, etc., may also be used.

The particular advantage of the specific embodiment according to FIG. 6 is that pumped light feed 100 not only supplies laser device 26 with pumped light, but also mechanically stabilizes the arrangement of the components provided by guide 28b.

Guide 28b may extend peripherally, i.e., along the entire circumference of pumped light feed 100 and laser device 26 or, as shown, extend only along certain portions of the circumference that advantageously subdivide the circumference into angle sections of the same size.

As an alternative to guide 28b shown in FIG. 6, laser device 26 may have a thread on the periphery at its end facing pumped light feed 100 that also has input mirror 42 (FIG. 2) that cooperates with a corresponding threaded section of pumped light feed 100 which is provided, for example, inside socket-shaped widening 28b. A configuration of this type allows, for example, axial relative movement of components 26, 100 with respect to each other due to the fact that laser device 26 is screwed into or unscrewed from the receptacle implemented by pumped light feed 100 driven by driver 200.

A further very advantageous specific embodiment of the example operating method according to the present invention provides that the operating information of laser device 26 such as a pulse energy of laser pulse 24 or a position in time of the generated laser pulse 24 is detected. An analysis of this type may, for example, be performed in such a way that a part of the radiation energy of generated laser pulse 24 is supplied to a detector, via an output optical device and the detector makes it possible to analyze the corresponding signals, for example, through a control unit 32 (FIG. 1) of laser device 26.

Instead of a separate extracting unit, fiber-optic section 28a, 28b of pumped light feed 100 according to FIG. 6 may also be used, for example, to supply radiation from laser device 26 to a detector (not shown).

In particular, analysis of the operating information according to an example embodiment of the present invention may also include forming the derivative of the pulse energy of laser pulse 24 so that the modes in laser pulse 24 may also be advantageously deduced from the derivative of the pulse energy.

According to the present invention, a regulation may be advantageously provided which, by using driver 200 described above, modifies the pumped volume or the spatial distribution of the injected pumped light 60 in such a way that laser pulse 24 may have a predefinable mode configuration.

In another very advantageous specific embodiment of the method according to the present invention it is provided that the detected operating information is subjected to a plausibility check, in particular by using model 32a (FIG. 1). Model 32a may be implemented, for example, in an arithmetic unit of control device 32 in the form of a computer program and may model the main operating sequences of laser device 26. Model-based output quantities such as the pulse energy of generated laser pulse 24 and the like may be calculated as a function of the control quantities actually supplied to laser device 26 and compared with actual operating values obtained by measurement techniques and subjected to a plausibility check.

In another specific embodiment laser device 26 according to the present invention may very advantageously also have a sensor 210 (FIG. 6) that makes it possible to ascertain a position or at least a relative placement of components 26, 100 with respect to each other. Sensor 210 may be particularly advantageously structurally integrated with driver 200.

In particular, when designing an actuator that may be manually operated such as an adjustable screw for adjusting the placement of components 26, 100, sensor 210 provided according to the present invention may make verification of the adjustment made possible.

Therefore, the position may also be controlled using automatic driver 200 and the information provided by sensor means 210 according to the present invention, whose subject matter is to regulate the pumped volume acted upon by pumped light 60.

In an especially advantageous further variant of the operating method according to the present invention, by targeted variation of the pumped volume, multiple breakthroughs of laser device 26 may be accomplished, which consequently makes generating a plurality of laser pulses 24 in short succession possible.

Contrary to the conventional operating methods which generate a plurality of laser pulses of this type by simply increasing pumping time, by varying the pumped volume according to the present invention instead of varying the pumping time, the plurality of laser pulses 24 may be generated within a predefinable time that is clearly shorter than the increased pumping time necessary when using conventional methods. If, for example, the operating point of internal combustion engine 10 (FIG. 1) is associated with a comparatively small flow velocity of the air/fuel mixture at ignition point ZP, more laser pulses 24 may advantageously be irradiated to ignition point ZP by varying the pumped volume according to the present invention and thus the total ignition energy may be advantageously increased without prolonging the ignition process as it happens when the pumping time is increased. This is accomplished, according to an example embodiment of the present invention, by decreasing the pumped volume of laser device 26 because the required breakthrough intensity in laser device 26 is reached earlier and thus laser operation in laser device 26 begins after a shorter time.

A further application where changing the pumped volume according to an example embodiment of the present invention may be used advantageously is when, for example, the pumping capacity drops during the operation of ignition device 27, which may be due to the degradation of pumped light source 30, for example. A drop in pumping capacity results in a clear reduction of pulse energy of laser pulse 24 in conventional systems or even in unstably timed laser pulses 24 because the laser operation begins relatively late after the start of pumping. In extreme cases, conventional laser equipment may break down completely because no more laser pulses 24 are generated. Instabilities of this type and even failure to generate laser pulses 24 may be compensated for at least partially or avoided by adjusting the pumped volume according to the present invention. When, for example, the pumping capacity provided by pumped light source 30 drops measurably, the example operating method according to the present invention provides for lowering of the pumped volume, which advantageously involves increased radiation density in laser device 26, which is in turn necessary for the reliable start of laser operation of laser device 26.

Impairment of characteristics of laser device 26 itself, such as degradation of the optical characteristics of input and output mirrors 42, 48 may also result in laser pulses 24 having reduced pulse energy or even missed laser pulses. Changes of this type may also be advantageously compensated for by a method according to the present invention by adjusting the pumped volume accordingly.

In addition to the analysis of performance quantities of laser device 26 itself described above, other performance quantities of internal combustion engine 10 (FIG. 1) such as sensor information of a thermoelement in an exhaust pipe (recognition of misfiring) or the like may also be considered in order to control or regulate the operation of laser device 26 according to the present invention.

In addition, changing the pumped volume according to the present invention advantageously makes reduction of the optical load on mirror layers 42 and 48 also possible. As long as a relatively low pulse energy of laser pulse 24 is sufficient for reliable ignition to take place, for example, the required pumped volume and/or the spatial distribution of pumped light 60 may be adjusted in such a way that it results in an operation of laser device 26 that spares components 42 and 48 in particular where, for example, high radiation densities are not unnecessarily used.

Changing the pumped volume according to the present invention, as described above, may also be used to excite different specific laser modes. Thereby even the direct focusing ability of laser pulse 24 generated by laser device 26 may be influenced, for example. For example, the operating method according to the present invention may advantageously provide a preferably multimodal excitation of higher-order modes, in particular, so that relatively high radiation intensities in laser pulse 24 are provided also in areas radially distant from the center of the beam cross section, which favors the focusing ability of laser pulse 24.

When a piezoelectric actuator is used for moving laser device 26 or pumped light feed 100 or their components, a lever mechanism may also be advantageously provided that enlarges the actuator stroke of the piezoelectric actuator.

In addition to a model-based control of generating laser pulse 24 or monitoring the operation, the capability of driving means 200 to spatially adjust the components of laser device 26 or pumped light feed 100 may also be controlled or regulated in a model-based manner in order to even out the fluctuations in manufacturing accuracy or other tolerances for guidance 28b (FIG. 6) of laser device 26 in pumped light feed 100, for example.

1-30. (canceled)

31. A method for operating a laser device having a laser-active solid and a Q-switch, comprising:
acting upon the laser device by pumped light to generate a laser pulse; and
changing a pumped volume of the laser-active solid.

32. The method as recited in claim 31, wherein the changing of the pumped volume includes moving one of: i) components of the laser device, or ii) the laser device and components of a pumped light feed supplying the pumped light in relation to one another.

33. The method as recited in claim 32, wherein the laser-active solid is moved at least one of axially and radially, relative to the pumped light feed.

34. The method as recited in claim 32, wherein the pumped light feed is moved at least one of axially and radially, relative to the laser-active solid.

35. The method as recited in claim 31, wherein at least one of: i) at least one component of the laser device is rotated about an axis of rotation, and ii) an optical input system of a pumped light feed supplying the pumped light is rotated about an axis of rotation.

36. The method as recited in claim 32, wherein the moving includes using a driver to move the components, the driver including at least one of a piezoelectric element, an electric motor, a hydraulic actuator, a pneumatic actuator, an actuator that may be manually operated, and an adjusting screw.

37. The method as recited in claim 31, further comprising:
detecting operating information of the laser device, the operating information including at least one of an energy and timing of a generated laser pulse.

38. The method as recited in claim 37, wherein modes contained in the laser pulse are inferred from the energy of the laser pulse.

39. The method as recited in claim 31, further comprising:
detecting a position of at least one of: i) components of the laser device, ii) the laser device itself, iii) components of the pumped light feed, and iv) an arrangement of corresponding units relative to each other.

40. The method as recited in claim 37, further comprising:
checking the operating information for plausibility using a model.

41. The method as recited in claim 37, wherein the pumped volume is changed as a function of the detected operating information.

42. The method as recited in claim 41, wherein the pumped volume is changed as a function of its plausibility.

43. The method as recited in claim 37, wherein a change in the optical characteristics of an input mirror of the laser device is inferred from the detected operating information in regard to signs of wear and tear or permanent damage.

44. The method as recited in claim 43, wherein a spatial distribution of the pumped light fed to the input mirror is changed as a function of the change in the optical characteristics of the input mirror.

45. The method as recited in claim 43, wherein a spatial distribution of the pumped light fed to the input mirror is changed at least one of continuously and periodically, via a relative movement between the pumped light feed and the input mirror.

46. The method as recited in claim 32, wherein one of: i) at least one part of the pumped light feed is guided mechanically either in or on a component of the laser device, or ii) the component of the laser device is guided mechanically, the guidance allowing at least one of translation and rotation of the pumped light feed in regard to the laser device.

47. The method as recited in claim 46, wherein at least a part of the guidance includes a waveguide function at the same time to inject pumped light into the laser device.

48. The method as recited in claim 32, wherein the pumped light feed is connected to the laser device via a threaded joint so that a rotation of the pumped light feed in relation to the laser device causes a distance between the pumped light feed and the laser device to change.

49. The method as recited in claim 32, wherein at least one flexible optical fiber of the pumped light feed is held in a rotatably mounted holding disc and is moved by rotation of the holding disc, the holding disc having at least one excentrically situated bore hole for accommodating at least one flexible optical fiber.

50. A method for operating a laser device, comprising:
providing an ignition device for an internal combustion engine of a motor vehicle, the ignition device including a laser-active solid and a Q-switch;
acting upon the laser device by pumped light to generate a laser pulse; and
changing a pumped volume of the laser-active solid.

51. A laser device comprising a laser-active solid and a Q-switch, the laser device adapted to be acted upon by pumped light to generate a laser pulse, wherein a pumped volume of the laser-active solid is able to be changed.

52. The laser device as recited in claim 51, wherein components of the laser device or the laser device, and components of a pumped light feed supplying the pumped light may be moved relative to each other.

53. The laser device as recited in claim 52, further comprising:
a driver adapted to move the components of the laser device or the pumped light feed, the driver including at least one of a piezoelectric element, an electric motor, a hydraulic actuator, a pneumatic actuator, and an actuator that may be manually operated.

54. The laser device as recited in claim 52, further comprising:
a sensor to detect a position of at least one of the components of the laser device, the laser device itself, components of the pumped light feed, and an arrangement of the corresponding units relative to each other.

55. The laser device as recited in claim 52, further comprising:
a guidance that cooperates with a component of the pumped light feed, the guidance allowing at least one of translation and rotation of the pumped light feed in regard to the laser device.

56. The laser device as recited in claim 55, wherein at least one part of the guidance conducts light to inject pumped light into the laser device.

57. The laser device as recited in claim 55, wherein the guidance is formed via a socket-shaped end section of the pumped light feed, which surrounds an end section of the laser device facing the pumped light feed.

58. The laser device as recited in claim 52, wherein the laser device is connected to the pumped light feed via a threaded joint so that a rotation of the pumped light feed in relation to the laser device causes a distance between the pumped light feed and the laser device to change.

59. The laser device as recited in claim 58, wherein a thread of the threaded joint is situated one of on an outside of laser device, or on a housing accommodating the laser device.

60. The laser device as recited in claim 52, wherein the pumped light feed has at least one flexible optical fiber, and the device further comprising:
a rotatably mounted holding disc adapted to at least one of hold and move the at least one flexible optical fiber, the holding disc having at least one eccentrically situated bore hole to accommodate the at least one flexible optical fiber.

61. An ignition device for an internal combustion engine of a motor vehicle, comprising:
a laser device including a laser-active solid and a Q-switch, the laser device adapted to be acted upon by pumped light to generate a laser pulse, a pumped volume of the laser-action solid being able to be changed.
